(19) United States
(12) Patent Application Publication
(10) Pub. No.: US 2008/0264309 A1
(43) Pub. Date: Oct. 30, 2008

(54) Multifunctional, Portable Security System

(76) Inventor: Peter Villiger, Beinwil (CH)

Correspondence Address: MCCARTER & ENGLISH LLP;CITYPLACE I, 185 ASYLUM STREET, HARTFORD, CT, 06103, US

(21) Appl. No.: 11/664,485

(22) PCT Filed: Sep. 21, 2005
(86) PCT No.: PCT/EP2005/054733

§ 371 Date: Apr. 3, 2008

(30) Foreign Application Priority Data
Oct. 1, 2004 (CH) 01608/04

(51) Int. Cl. E05G 1/14; E05G 1/00

(52) U.S. Cl. 109/25; 109/38

(57) ABSTRACT

Security system (100) having a container (20), which encloses a strongbox area (22) for receiving valuables (42). Means for carrying (10) the container (20), a protection system (12) for protecting the valuables (42) located in the strongbox area (22), and an access opening (23) are provided. At least one protection module (23; 41) is provided in the strongbox area (22), the protection module (23; 41) being designed for the purpose of neutralizing the valuables (42) located in the strongbox area (22). The means for carrying (10) are implemented as a separate module, which comprises a handle area (11.1, 11.2), a mechanical interface (13; 13.1, 13.2) for the mechanical connection to the container (20), a security circuit (12) for securing the security system (100), and a security interface (12.1) for establishing a communication link between the security circuit (12) and the protection module (23; 41).

The present invention relates to a portable security system according to the preamble of Claim 1.

There are greatly varying security cases for transporting objects in need of protection, such as valuables like coins and banknotes, securities, other valuable objects such as precious metals and precious stones, documents to be kept secret, or possibly also toxic materials, rare materials, or material to be shielded in another way, such as radioactive material.

The security cases typically have a strongbox area, a protection system, and an access opening, which may be closed and makes the security case accessible in the open state.

The protection system is used for the purpose of protecting the owner or possessor of the valuables from a misuse of the valuables, if they are lost in the event of a theft. This is performed by automatically neutralizing and/or devaluing the valuables in such a case. The corresponding known protection systems are costly and complex.

As already noted, there are different types of valuables to transport. The cases must have different sizes depending on the type of the valuables. In addition, greatly varying security guidelines may apply. In practice, there is therefore a large number of greatly varying cases in use.

It is important for cases of this type that they correspond to the corresponding security guidelines, are portable, and above all are flexibly usable. Current cases only partially fulfill these criteria. In addition, the cases are currently relatively expensive.

It is the object of the present invention,
to provide a security system of the type cited at the beginning, which ensures high security and is simple to handle,
to suggest a multifunctional security system of type cited at the beginning, which allows high flexibility in its operability, and
to provide a security system of the type cited at the beginning, which is cost-effective.

This object is achieved
for a security system by the characterizing features of Claim 1.

Preferred refinements of the security system are defined by the dependent claims.

The protection system comprises at least one protection module, which is housed either in the strongbox area of the container or in a cassette to be transported, such as a currency cassette. In an emergency, i.e., if the security system is wrongfully handled or actuated, the valuables located therein are neutralized (devalued), i.e., they are damaged or destroyed.

The valuables are preferably packed in currency cassettes (ATM cassettes) and these currency cassettes are then laid or inserted into the strongbox area. These currency cassettes have a communication interface to connect them with a circuit of a separate (portable) module. In case of emergency, a protection module located in the currency cassette is triggered to neutralize the valuables using ink or a similar material.

A handle or a recessed grip is situated on the separate (portable) module, at which the entire security system may be carried manually, possibly with the aid of an auxiliary device. The recessed grip may be implemented in such a way that it has a light barrier or a mechanical interrupter. As soon as a currency carrier or another authorized person lets go of the security system, the neutralization procedure is triggered. This procedure may be implemented in multiple stages and is externally settable in a preferred embodiment (by a Pocket PC or a computer via an interface).

A part of the protection system, namely the security circuit, is housed in the separate (portable) module. This part is the most expensive of the entire security system. Therefore, the module is designed according to the present invention in such a way that it may be placed on various containers. Such a container then becomes a component of the overall security system due to the connection to the module.

The security circuit is preferably an electrical/electronic circuit. This security circuit is a part of the protection system. It is an advantage of the present invention that this part of the protection system is located in a protected area of the (portable) module and therefore may not be externally accessed or influenced.

In an especially advantageous embodiment, an access opening is located in the upper wall (cover) of the container. The cover is secured by the docking of the (portable) module.

Further features and characteristics of the present invention are explained in greater detail in the following on the basis of exemplary embodiments and with reference to the drawing.

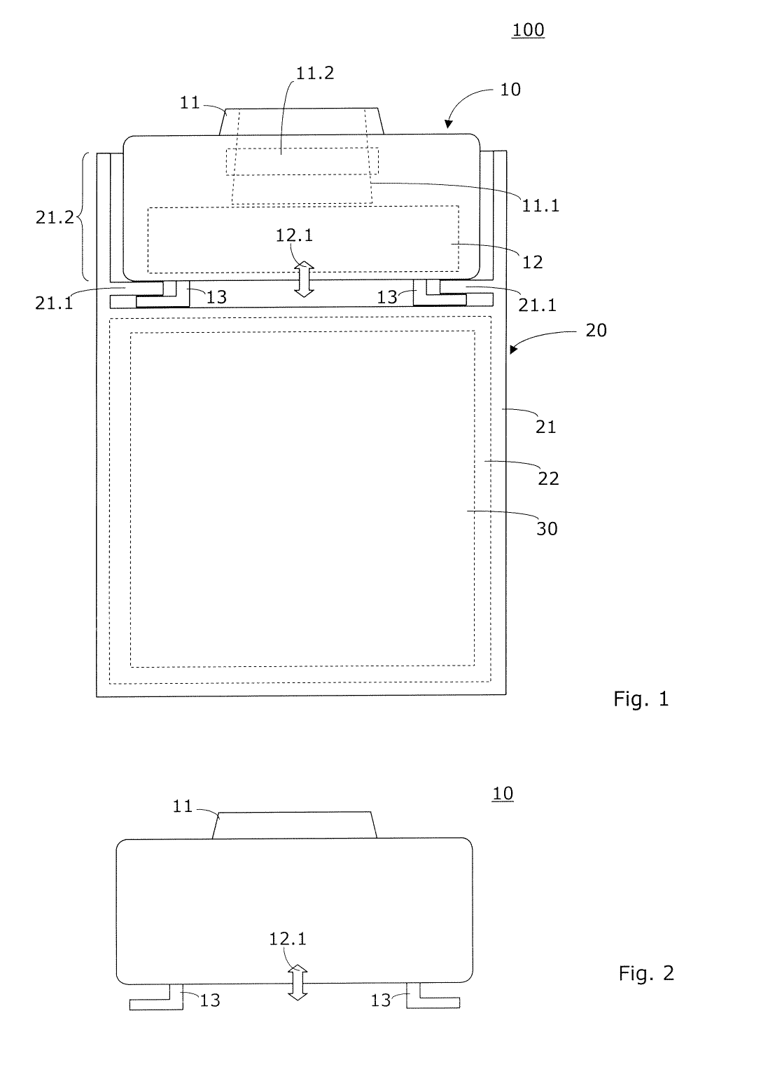

FIG. 1 shows a first security system according to the present invention, in a schematic side view;

FIG. 2 shows a schematic side view of a (portable) module according to FIG. 1;

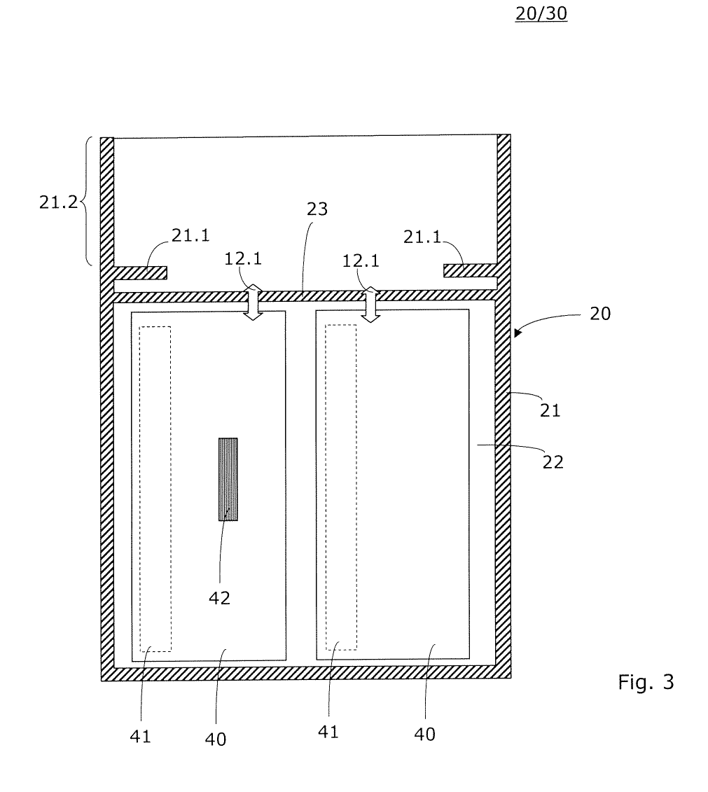

FIG. 3 shows a second security system according to the present invention, in a schematic sectional view;

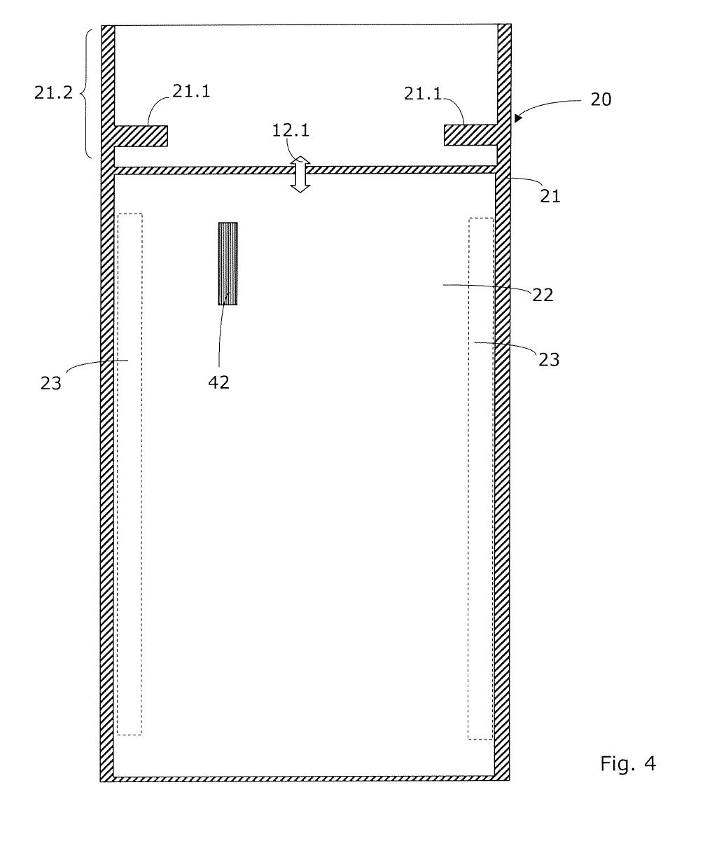

FIG. 4 shows a third security system according to the present invention, in a schematic sectional view;

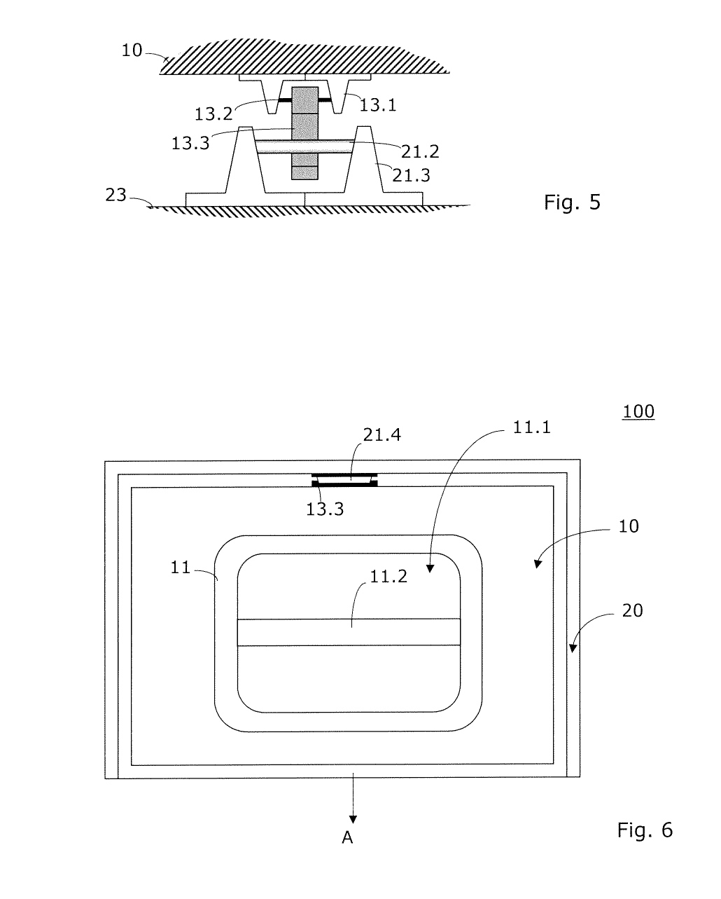

FIG. 5 shows a schematic detail of the mechanical connection between a (portable) module and a container, according to the present invention;

FIG. 6 shows a fourth security system according to the present invention, in a schematic top view;

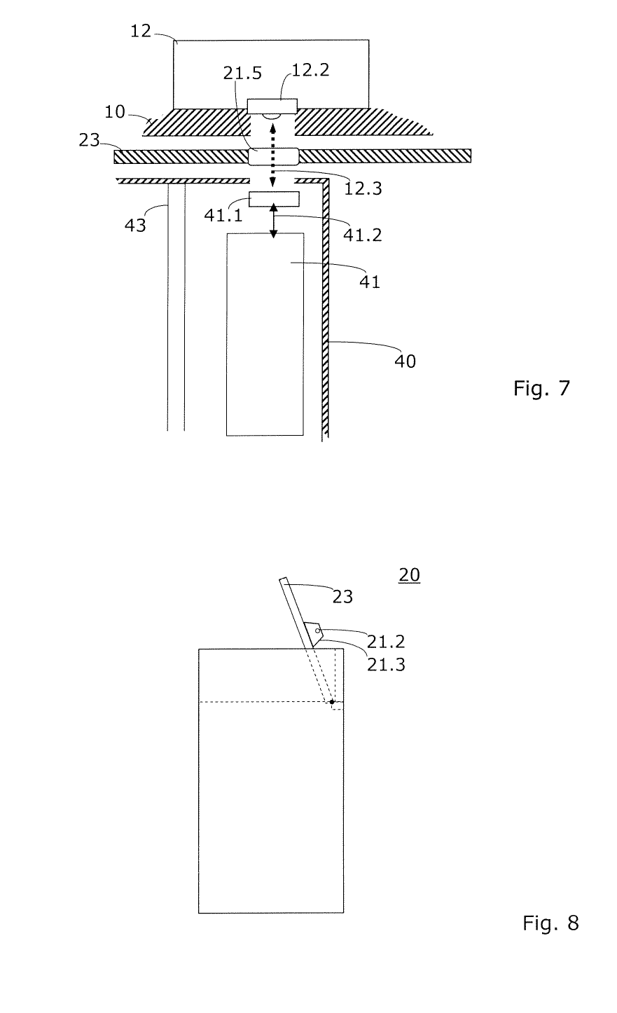

FIG. 7 shows a schematic detail of the mechanical connection between a further (portable) module and a container according to the present invention;

FIG. 8 shows a container according to the present invention, in a schematic side view, and

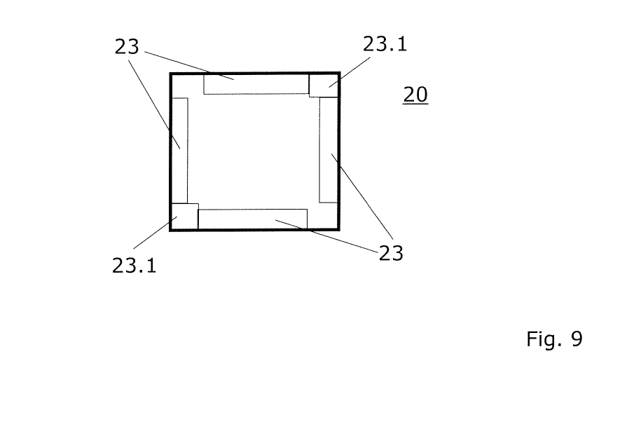

FIG. 9 shows a security container according to the present invention having additional security precautions, in a horizontal section.

Constructive elements which are identical and/or act identically in principle are provided with identical reference signs in the figures, even if they partially differ from one another.

FIG. 1 shows a schematic view of a first embodiment of the present invention. A security system 100 is shown, which is used for receiving the valuables, in particular during transport. To be able to explain the details of the present invention better, elements which are seated in the interior are indicated by dashed lines in FIG. 1.

The security system 100 comprises a container 20, which encloses a strongbox area 22 for receiving valuables. Means 10 are provided for carrying the container 20. Furthermore, a protection system 12 is provided for protecting the valuables located in the strongbox area 22. The container 20 has an access opening to open the container 20 and make the strongbox area 22 accessible. This access opening is preferably located in a cover of the container 20. According to the present invention, at least one protection module is provided in the strongbox area 22. This protection module is either seated in the strongbox area 22 itself (cf. FIG. 4) or a (currency) cassette 30 or 40 (cf. FIG. 3) is introduced or inserted into the strongbox area 22.

According to the present invention, the protection module is designed for the purpose of neutralizing the valuables located in the strongbox area 22. The means 10 for carrying are implemented according to the present invention as a separate (portable) module, which has a handle area 11.1 having a handle 11.2. Furthermore, a mechanical interface 13 is provided for the mechanical connection to the container 20. An embodiment is shown in FIG. 1, in which the (portable) module 10 has two angles 13 or rails on the bottom. Two counterparts 21.1, such as angles or rails, are provided on the container 20. In the example shown, the (portable) module 10 may be pushed onto the container 20 from the front and docked in this way. The container 20 is preferably equipped with a docking area 21.2 for this purpose.

As indicated in FIG. 1, the (portable) module 10 comprises a security circuit 12 for securing the entire security system 100. According to the present invention, a security interface 12.1 is provided to be able to establish a communication link between the security circuit 12 and the protection module in the strongbox area 22. This security interface 12.1 is indicated by a double arrow in the figures, because it is a security interface which permits two-way communication.

In the security system 100 shown in FIG. 1, a (currency) cassette 30 is stored and protected in the strongbox area 22.

A side view of the (portable) module 10 without container 20 is shown in FIG. 2. The (portable) module 10 is preferably manufactured from Kydex®, to prevent manipulation or damage. The (portable) module 10 shown may be combined with greatly varying containers. Therefore, a container which corresponds to the current requirements may be selected as needed. Depending on the number of currency cassettes to be retrieved, for example, a small or a large container may be taken along by the currency carrier. The currency carrier may grasp and carry the container by simple docking.

After the (portable) module 10 has been removed, the container 20 is preferably switched into a special mode to ensure additional protection against manipulation. During the transport using the (portable) module 10, the security circuit 12 may assume control over certain functions.

A schematic section through another container 20 is shown in FIG. 3. The docking point 21.1 is recognizable in the upper area. Two rails 21.1 are provided on the lateral walls. However, there are also other possibilities for producing a mechanically detachable connection between such a (portable) module 10 and a container 20. In the example shown, two (currency) cassettes 40 are located in the strongbox area 22. The cassettes 40 both stand upright and are inserted from above when cover 23 is open. At least one protection module 41 is located in each of the cassettes 40. There is space for valuables 42, such as banknote bundles, next to the protection modules 41. There is a security interface 12.1 with each of the two cassettes 40.

FIG. 4 shows a further container 20, which is taller than that shown in FIG. 3. This container 20 is designed for the purpose of directly receiving valuables 42. In order to ensure this protection, protection modules 23 are situated on both sides. There is also a security interface 12.1 here to connect a docked (portable) module 10 to the protection modules 23, so that they may be triggered in case of emergency to neutralize the valuables.

According to the present invention, it is especially important that a mechanically stable connection is easily producible between the (portable) module 10 and a container 20. However, this mechanical connection must be easily detachable again, in order to be able to remove the (portable) module 10 and use it in another way. A stable mechanical connection is necessary in particular because the security interface 12.1 between the (portable) module 10 and the container 20 must function reliably and without malfunction.

A detail of a security system is shown in FIG. 5 to be able to explain a possible embodiment of the mechanical connection. In the embodiment shown, a latch 13.3, which is mounted movably in a bearing 13.1 via an axis 13.2, is seated on the bottom of the (portable) module 10. This latch 13.3 may be pivoted out of the plane of the drawing or into the plane of the drawing. On the opposite side, an element 21.2 is located on the cover 23 of the container 20, in which the latch 13.3 may latch. The element 21.2 is supported by a bearing 21.3.

Instead of one latch 13.3, two separate latches may also be used. However, it is also possible according to the present invention to operate entirely without latches, as indicated in FIG. 1.

It is expressly noted that the methods and devices described for docking are solely to be viewed as examples, and greatly varying other methods, in particular mechanical, pneumatic, and electromechanical types, may be used for docking.

An example of an electrical connection is shown in a top view in FIG. 6. In the illustration shown, a (portable) module 10 is seated in the docking area on the container 20. The recessed grip 11.1 having the handle 11.2 may be recognized in FIG. 6. As indicated by an arrow A, the (portable) module 10 may be pulled out of the docking area 12.1. A plug element 13.3 is located on the rear of the (portable) module 10, which produces an electrical connection to a plug element 21.4, which is located on a rear wall of the container 20, in the docked state.

FIG. 7 shows a schematic section through a part of a security system. The construction of a possible embodiment of a contactless connection 12.1 is explained on the basis of this section. A security circuit 12 is seated inside the (portable) module 10. Only a lower wall of the (portable) module 10 is shown in FIG. 7. The security circuit 12 comprises a transmitter 12.2. This may be an infrared transmitter, for example. However, transmitters which operate in another wavelength range may also be used. An RF transmitter may also be used.

In the example shown, a (currency) cassette 40 is located inside the container 20. Only one corner may be recognized of this cassette 40. A protection module 41 is seated inside the cassette 40. A receiver (such as an IR detector) is seated in the upper area of the cassette 40, which is connected to a circuit or to the protection module 41, for example, as indicated in FIG. 7 by the arrow 41.2.

An opening is provided in each case in the lower wall of the (portable) module 10, the cover 23 of the container 20, and the cassette 40. When the (portable) module 10 and the container 20 are mechanically connected to one another (e.g., using hooks 13/rails 21.1 and/or using a latch connection) and the cassette 40 is held by a rail 43 in a permanently predefined position, for example, all three openings lie one above the other. A continuous optical link may thus be established, as indicated by the double arrow 12.3. A transparent element or a lens 21.5 may be provided in the cover 23 of the container 20.

Using an inductive or capacitive coupling as a link is also conceivable.

The communication link is preferably a link which allows encrypted communication.

A side view of an embodiment of the container 20 is shown in FIG. 8. The cover 23 of the container 20 is open and the strongbox area may be filled. In the embodiment shown, the cover 23 carries the two elements 21.2 and 21.3, which are shown in greater detail in FIG. 5. It is important that the cover 23 is protected against opening after the docking of the (portable) module 10.

The (portable) module 10 is generally used for the purpose of manually transporting the security system 100 without further aids. Measures may also be taken to manually lift and displace the security system 100 with the aid of an additional device, or to transport the security system 100 in an automated conveyance system.

It is also possible and may be used for increased security and/or standalone security if the container and the portable module are implemented in such a way that only one opening of the container coupled to the portable module is possible.

The recessed grip 11.1 or another area of the security system 100 may be implemented in such a way that it triggers the neutralization via a light barrier or a cable in the event it is snatched or put down. An interface may also be provided to be able to program the security system 100 externally using a PDA or a computer in combination with the recessed grip 11.1 or in another way.

The protection system having a security circuit and at least one protection module is used for the purpose of protecting the valuables 42 located in the strongbox area 22 in case of emergency, i.e., for example in the event of handling or actuation of the security system 100 by an individual unauthorized for this purpose, or above a specific temperature. This protection comprises preventing misuse of the valuables 42 by neutralizing (devaluing) them in some suitable way. This neutralization may be performed, for example, in such a way that the valuables 42 may retain or reacquire their value for the authorized owner or possessor.

In the present exemplary embodiment, the protection modules 23, 41 are modules having free-flowing materials which, preferably under pressure, discharge powdered, pasty, or liquid materials, in particular inks, preferably from two sides, onto the valuables 42, by which the latter are devalued.

As shown in FIG. 9, for example, four protection modules 23 may also be provided, which are situated in such a way that the free-flowing materials are discharged from multiple directions onto the valuables in the strongbox area, to ensure that each of the valuables is reached by free-flowing material. In any case, it is advantageous to situate more than one protection module 23.

As also shown in FIG. 9, a heater may be provided for additional security of the valuables, using which receptacles, in particular plastic receptacles, which contain the valuables may be melted, so that the valuables are actually reached by the free-flowing materials such as inks, even if they are supplied in such receptacles. The heater may be started by activated ignition fuses. These ignition fuses may be situated separately, as indicated schematically by 23.1, or may be inserted into a housing and/or a housing wall of the modules 23 containing the free-flowing material.

The protection system may be implemented in such a way that it is possible to access the strongbox area 22 with or without actuation of an additional auxiliary element such as a (contactless) key.

The valuables may additionally be protected by providing a mechanical or electronic seal. Such a seal is not primarily intended to obstruct opening of the container, but rather to be able to establish unauthorized, but unforced opening, for example, by the currency carrier himself.

Finally, the container 20 may also be implemented in such a way that it has a separate security electronic system, which may be implemented similarly to the security circuit of a (currency) cassette.

A thermoplastic material, preferably a Kydex® material, has been shown to be a suitable material for the container 20 and/or the (portable) module 10 or for parts thereof. However, greatly varying other materials are also suitable for producing the security system 100.

The security system 100 preferably has a surface protection. For this purpose, the security system 100 may be provided with a protective film, a net, or a fabric to provide a protection against breaking open, cutting through, or drilling through.

In another preferred embodiment, the security system 100 may have an interface to read an RFID chip or a barcode in order to only then allow release (opening). Such an RFID chip or barcode may be situated at the target location (for example, at a bank). The security system 100 is only released after recognition of the RFID chip or the barcode.

A time window may preferably be predefined for the circuit of the (portable) module 10, the automatic neutralization being initiated after the time window has been exceeded.

The security circuit 12 is preferably designed in such a way that in case of emergency an LED begins to blink after a bouncing time. A prealarm then occurs, for example, acoustically, followed by a main alarm. The neutralization only occurs after this alarm phase. This sequence is preferably externally programmable (using a Pocket PC or computer).

Smoke is preferably discharged by the security modules in the security case upon the neutralization. This has a signal effect and thus prevents a perpetrator from carrying along the security case.

A further security precaution may comprise situating an airbag system on the container, for example. Such an airbag system must be conceived in such a way that it is activated or activatable in the event of unauthorized handling of the container. Unauthorized handling and transport of the container is made more difficult by the volume increase occurring upon actuation of the airbag system.

1. A security system (100) having
a container (20), which encloses a strongbox area (22) for receiving valuables (42),
means for carrying (10) the container (20),
a protection system (12) for protecting the valuables (42) located in the strongbox area (22),
an access opening (23), to be able to open the container (20) and make the strongbox area (22) accessible,
characterized in that
at least one protection module (23; 41) is provided in the strongbox area (22), the protection module (23; 41) being designed for the purpose of neutralizing the valuables (42) located in the strongbox area (22),
the means for carrying (10) being implemented as a separate module, which comprises
a handle area (11.1, 11.2),
a mechanical interface (13; 13.1, 13.2) for the mechanical connection to the container (20),
a security circuit (12) for securing the security system (100), and
a security interface (12.1) for establishing a communication link between the security circuit (12) and the protection module (23; 41).

2. The security system (100) according to claim 1, characterized in that the container (20) has a receptacle area (21.2), which allows docking of the separate module (10), both the mechanical connection and also the establishment of the communication link occurring upon the docking.

3. The security system (100) according to claim 2, characterized in that guide elements (21.1) are provided in the receptacle area (21.2), in order to be able to insert the separate module (10).

4. The security system (100) according to claim 1 or 2, characterized in that one or more latch elements (13.1, 13.2, 21.2, 21.3) are provided on the container (20) and/or on the separate module (10), to be able to mechanically latch the separate module (10) onto the container (20).

5. The security system (100) according to one of the preceding claims, characterized in that the security interface (12.1) is implemented as a plug-in connection (13.3, 21.4), in which a first plug element (13.3) on the separate module (10) is pluggable into a second plug element (21.4) on a container (20).

6. The security system (100) according to one of claims 1 through 4, characterized in that the security interface (12.1) is implemented as a contactless connection (12.3), in which a transmitter (12.2) interacts with a receiver (41.1), this preferably being an infrared interface and the communication link allowing encrypted communication.

7. The security system (100) according to one of the preceding claims, characterized in that the container (20) and/or the separate module (10) is at least partially produced from thermoplastic material, preferably Kydex® material.

8. The security system (100) according to one of the preceding claims, characterized in that the protection module (23; 41) is filled with a free-flowing material, such as liquids like ink, and discharges this material under pressure to neutralize the valuables (42), in particular securities and bank notes.

9. The security system (100) according to one of the preceding claims, characterized in that the security circuit (12) is connectable via the security interface (12.1) to the protection module (23; 41) and causes triggering of the protection module (23; 41) as soon as there is unauthorized manipulation of the security system (100) or the security system (100) is released from the hand.

10. The security system (100) according to one of the preceding claims, characterized in that it has a further interface to allow settings of the security circuit (12) using a Pocket PC or computer.

11. The security system (100) according to one of the preceding claims, characterized in that the container (20) is provided for receiving currency cassettes (40), these preferably being currency cassettes (40) which are used in ATMs.

12. The security system (100) according to claim 11, characterized in that the security circuit (12) establishes the communication link (12.3, 41.2) via the interface (12.1) with the currency cassettes(s) (40) after the currency cassettes(s) (40) have been introduced into the strongbox area (22).

13. The security system (100) according to one of the preceding claims, characterized in that the container (20) has a size and shape which is designed for the type of valuables (42) to be transported.
